(19) United States
(12) Patent Application Publication
(10) Pub. No.: US 2013/0230834 A1
(43) Pub. Date: Sep. 5, 2013

(54) METHOD FOR TREATING POST-TRAUMATIC STRESS DISORDER

(71) Applicant: Frank J. Bourke, Corning, NY (US)

(72) Inventor: Frank J. Bourke, Corning, NY (US)

(21) Appl. No.: 13/770,556

(22) Filed: Feb. 19, 2013

Related U.S. Application Data
(60) Provisional application No. 61/600,174, filed on Feb. 17, 2012.

(51) Int. Cl. G09B 19/00

(52) U.S. Cl. CPC G09B 19/00
USPC 434/236

(57) ABSTRACT

The subject matter disclosed in this specification pertains to a method for treating post-traumatic stress disorder. An individual is asked about a problem state and feedback is observed. When the individual is identified entering the problem state, the state is broken. The individual is requested to engage in a first visualization of an unrelated event while in a dissociated state, a second visualization of the traumatic event while in a dissociated state and third visualization of the traumatic event while in an associated state but wherein the event is played in reverse.

### CROSS-REFERENCE TO RELATED APPLICATIONS

This application claims priority to U.S. provisional patent application 61/600,174 (filed Feb. 17, 2012), the content of which is hereby incorporated by reference.

### BACKGROUND OF THE INVENTION

The subject matter disclosed herein relates to methods of treating post-traumatic stress disorder (PTSD) and method for recording the progress of such treatments overtime.

Post-traumatic stress disorder (PTSD) is an anxiety-type disorder that can occur after an individual has experienced or seen a traumatic event, often that involved the threat of injury or death. PTSD alters the body's response to stress and otherwise has pronounced effects on the psychological and physical health of the individual. Current treatments often involve having the individual “relive” the traumatic event in an effort to desensitize them. Unfortunately, these treatments are not entirely satisfactory. Alternative treatment method are therefore desirable.

The discussion above is merely provided for general background information and is not intended to be used as an aid in determining the scope of the claimed subject matter.

### BRIEF DESCRIPTION OF THE INVENTION

The subject matter disclosed in this specification pertains to a method for treating post-traumatic stress disorder. An individual is asked about a problem state and feedback is observed. When the individual is identified entering the problem state, the state is broken. The individual is requested to engage in a first visualization of an unrelated event while in a dissociated state, a second visualization of the traumatic event while in a dissociated state and third visualization of the traumatic event while in an associated state but wherein the event is played in reverse.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a flow diagram of a method for treating post-traumatic stress disorder; and

FIG. 2 is a flow diagram depicting method for treating post-traumatic stress disorder.

### DETAILED DESCRIPTION OF THE INVENTION

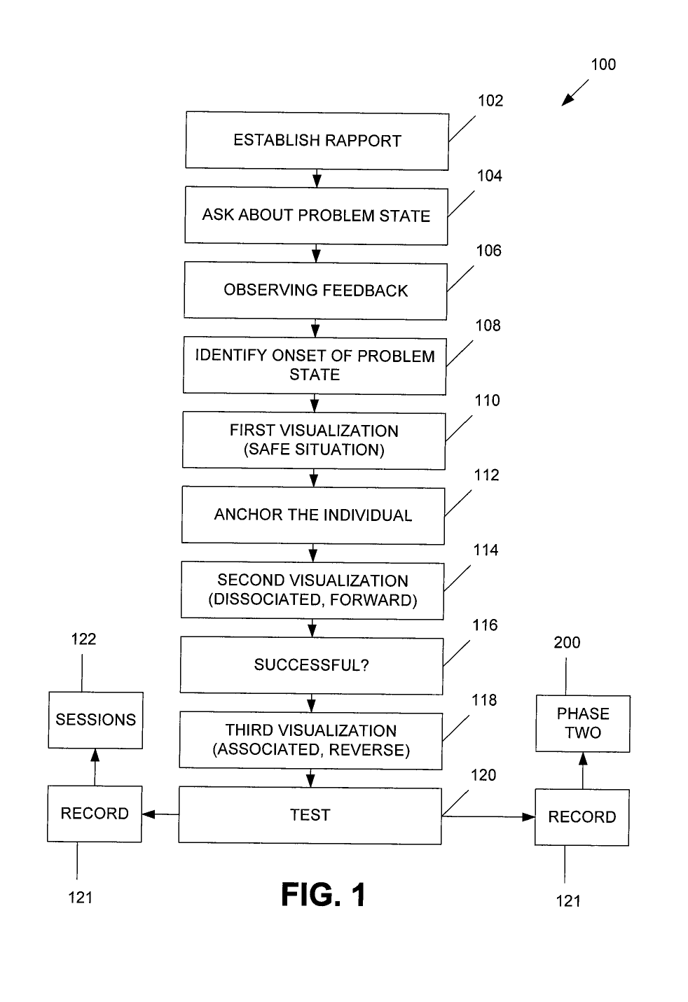

FIG. 1 is a flow diagram of a method 100 for treating post-traumatic stress disorder. Method 100 is phase one of a treatment protocol. The method 100 comprises step 102 wherein a rapport is established with an individual who is suffering from post-traumatic stress disorder (PTSD). During step 102, a therapist may explain to the individual that the method is ordinarily comfortable but may have very short periods of moderate discomfort. The therapist may also ask about previous attempted therapies and/or explain how method 100 is very different from conventional PTSD therapies. For example, the therapist may explain that the method 100 does not involve re-living traumatic events, catharsis or a release of feelings. In some embodiments of the method, the therapist may also the individual to establish a kinesthetic anchor through touch. For example, the therapist may place his or her hand on the forearm of the individual and ask if such touching is permissible. If permission is not granted, the therapist may further indicate that such kinesthetic anchor is not essential.

In step 104, the therapist asks about a problem state that is believed to be responsible for the PTSD. Exemplary questions include: “What is your problem and how does it present itself?” “What is the traumatic event or events that caused it?” “What does the problem trouble you most?” “What are the symptoms associated with the problem?” “Where are any unpleasant feelings located in the body?” “What is it like when you experience these symptoms?”

Step 106 is performed simultaneously with step 104. In step 106 the therapist observes feedback from the individual. Specifically, the therapist will attend to the physiological and paralinguistic elements that reflect heighted arousal and the elicitation of the problem state. The therapist may be particularity watchful for observed elements indicative of fear or trauma. Changes in breathing, heart rate, skin tone and color, vocal pitch, speech rate, muscular tension, tremors and changes in posture may be observed by the therapist.

In step 108, the therapist identifies the individual entering the problem state based on the observables from step 106. The therapist may also be specifically observing what questions (step 104) specifically triggered the onset of the problem state. The therapist may also note whether the individual was focused inwardly or outwardly as problem state was entered. As soon as the therapist identifies the individual entering the problem state, the problem state is immediately interrupted. For example, the therapist may move into the client's field of vision and change the topic by, for example, discussing weather, favorite foods or any other innocuous topic that is unrelated to the problem state.

In step 110 the therapist requests the individual engage in a first visualization while they are in a dissociative state. In the first visualization the individual is requested to remain in a dissociated state with respect to the first visualization. The first visualization is of a neutral or otherwise safe event that is unrelated to the problem state. For example, the individual may be asked to engage in a first visualization that includes the individual sitting in a movie theater watching a still image of the individual performing a neutral activity in a safe context. Because the individual is an observer of the activity, rather than a participant, the individual is said to be in a dissociative state. Any suitable dissociative technique may be used including imagining a physical dissociation by floating away to a project booth behind a transparent barrier, floating away from the body and imagining that the individual is standing behind his or her body holding their own shoulders and monitoring their own embodied state or distorting the image sufficiently that no association to the image is possible.

In step 112 the therapist anchors the individual during the first visualization (step 110). The anchor may be a physical anchor (e.g. a few fingers or a hand placed on the individual's forearm) or a verbal anchor (e.g. repeating the word “Good” said slowly in a distinctive tone). In one embodiment, the anchor is distinctive and repeatable such that, over time, the individual is conditioned to respond to the stimulus with a feeling of being anchored in the same room with the therapist. The anchor provides a psychological anchoring point to keep the individual mentally present in the room with the therapist and prevent the visualization from overtaking the individual.

In step 114, after the individual has experienced the first visualization of a neutral activity, the individual is requested to engage in a second visualization. For example, the second visualization may comprise the individual in a movie theater viewing a pre-traumatic event still image of himself or herself. As the individual focuses on this still image, the therapist provides supplemental instructions to request the individual envision a movie of the traumatic event in a dissociated state, including progressing through the traumatic event to the point where the individual survived and thereafter hold this post-traumatic event still image in their mind. After receiving the supplemental instructions, the individual releases the pre-traumatic even still image, proceeds to visualize the traumatic event movie and finally holds the post-traumatic event still image in their mind. In one embodiment, the traumatic even movie is visualized in black and white to assist the individual in recognizing that the second visualization is not real. In one embodiment the therapist anchors the individual during the second visualization.

In step 116, an assessment is made to determine if the second visualization was successful. If the individual cannot complete the second visualization without significant distress, the process is repeated and a new anchor is recreated. Additionally, if the individual claims the second visualization was successful but the therapist is uncertain if the problem state occurred during the visualization (step 114) then the method 100 is repeated beginning with step 110. The therapist should be watchful for signs of mild distress. In one embodiment, the individual is requested to only engage in the second visualization by picturing a subsection of the movie. For example, only the top half, only the bottom half, only even or odd numbered seconds of the movie, etc. If the individual displays signs of acute distress, the second visualization may be interrupted. For example, the therapist may move into the client's field of vision and change the topic by, for example, discussing weather, favorite foods or any other innocuous topic that is unrelated to the problem state.

If the individual indicates the second visualization of the traumatic event can be performed without the problem state occurring and the therapist concurs that no observables of the problem state were evident, then the anchor may be removed and step 118 is executed.

In step 118, the individual envisions a third visualization. The third visualization comprises the post-traumatic event still image from the second visualization. The individual then envisions himself or herself as an active participant in the traumatic event (i.e. in an associated state) but wherein the traumatic event plays in reverse starting from the moment of the post-traumatic event still image. In one embodiment, the reverse vision is run at very high speeds. In one such embodiment, the reverse vision is pictured in color. In one embodiment, step 118 is performed only one time. In another embodiment, step 118 is performed several times.

In step 120, which is performed after step 118, the therapist attempts to trigger the problem state using knowledge gained during steps 104 and 106. The specific questions that are known to trigger the problem state are asked. If the problem state can be triggered then further sessions may be necessary (step 122). If the problem state could not be triggered then phase two (method 200) may be performed.

In some embodiments, step 121 is executed after step 120 wherein the results of the method are recorded. For example, the therapist may record observations that triggered the onset of the problem state. The therapist may record whether or not the problem state could be triggered in step 120 or the degree to which the problem state was manifested. Such records of therapy are useful to monitor the progress of the individual over a prolonged period of time. For example, the therapist may record these observations in a hand-written notebook or in an electronic device, such as a computer.

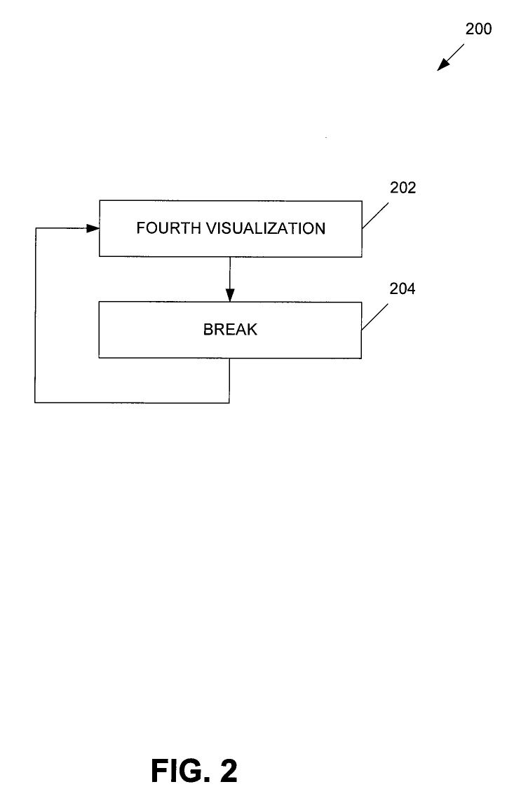

FIG. 2 is a flow diagram depicting method 200 for treating post-traumatic stress disorder. Method 200 is phase two of the treatment protocol. In step 202 of method 200, the therapist requests the individual engage in a fourth visualization that includes the traumatic event (in an associated state) but where the traumatic event has been altered such that the individual was not injured. For example, a third party may intervene or the individual may make a different decision. The fourth visualization, in one embodiments, recreates the traumatic event as nearly as possible except in that the individual is not injured.

In step 204, after one iteration of the fourth visualization, the visualization is interrupted. For example, the therapist may move into the client's field of vision and change the topic by, for example, discussing weather, favorite foods or any other innocuous topic that is unrelated to the problem state. The steps 202 and 204 may be repeated, for example, eight to ten times.

In a post-phase two assessment, the individual may be asked how they experienced the procedure. The therapist observes the non-verbal behavior of the individual. The individual should display a resourceful and untroubled physiology free of the indicia of trauma elicited at the evocation stage. The individual should be more congruent and balanced than at the end of the phase-one treatment.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for treating post-traumatic stress disorder, the method comprising the steps of:
asking an individual about a problem state;
observing feedback from the individual in response to the step of asking,
identifying the individual entering the problem state and immediately thereafter breaking the problem state;
requesting the individual engage in a first visualization of an event unrelated to the problem state while the individual is in a dissociated state with respect to the first visualization;
anchoring the individual during the first visualization;
requesting the individual engage in a second visualization of a traumatic event believed to be the cause of the problem state while the individual is in a dissociated state with respect to the second visualization, the second visualization comprising a pre-traumatic still image and a post-traumatic still image;
anchoring the individual during the second visualization;
removing the anchor after the second visualization is complete;
requesting the individual engage in a third visualization of the traumatic event while the individual is in an associated state with respect;
recording observations made during the first, second or third visualization for use in subsequent sessions.

2. The method as recited in claim 1, further comprising establishing a rapport with the individual.

3. The method as recited in claim 1, wherein the step of anchoring comprises providing a physical anchor by physically touching the individual.

4. The method as recited in claim 1, wherein the step of anchoring comprises providing a verbal anchor by repeating a keyboard.

5. The method as recited in claim 1, wherein the step of requesting the individual engage in the second visualization of the traumatic event is performed while the individual is visualizing a pre-traumatic event still image of the individual.

6. The method as recited in claim 1, further comprising assessing whether or not the third visualization was completed without the individual experiencing distress.

7. The method as recited in claim 6, where the individual was unable to complete the third visualization without experiencing distress, the method further comprising the step of reestablishing an anchor.

8. The method as recited in claim 6, where the individual was unable to complete the third visualization without experiencing distress, the method further comprising the step of interrupting the third visualization.

9. The method as recited in claim 1, further comprising requesting the individual engage in a fourth visualization of the traumatic event wherein the traumatic event is altered such that the individual is not injured.

10. The method as recited in claim 9, further comprising breaking from the fourth visualization and thereafter repeating the step of requesting the individual engage in the fourth visualization.

11. A method for producing a treatment record for post traumatic stress disorder which comprises an answerable record document with questions relating to:
asking an individual about a problem state;
observing feedback from the individual in response to the step of asking,
identifying the individual entering the problem state and immediately thereafter breaking the problem state;
requesting the individual engage in a first visualization of an event unrelated to the problem state while the individual is in a dissociated state with respect to the first visualization;
anchoring the individual during the first visualization;
requesting the individual engage in a second visualization of a traumatic event believed to be the cause of the problem state while the individual is in a dissociated state with respect to the second visualization, the second visualization comprising a pre-traumatic still image and a post-traumatic still image;
anchoring the individual during the second visualization; and
removing the anchor after the second visualization is complete.

12. The method as recited in claim 11, further comprising establishing a rapport with the individual.

13. The method as recited in claim 11, wherein the step of anchoring comprises providing a physical anchor by physically touching the individual.

14. The method as recited in claim 11, wherein the step of anchoring comprises providing a verbal anchor by repeating a keyboard.

15. The method as recited in claim 11, wherein the step of requesting the individual engage in the second visualization of the traumatic event is performed while the individual is visualizing a pre-traumatic event still image of the individual.

16. The method as recited in claim 11, further comprising assessing whether or not the third visualization was completed without the individual experiencing distress.

17. The method as recited in claim 16, where the individual was unable to complete the third visualization without experiencing distress, the method further comprising the step of reestablishing an anchor.

18. The method as recited in claim 16, where the individual was unable to complete the third visualization without experiencing distress, the method further comprising the step of interrupting the third visualization.

19. The method as recited in claim 11, further comprising requesting the individual engage in a fourth visualization of the traumatic event wherein the traumatic event is altered such that the individual is not injured.

20. The method as recited in claim 19, further comprising breaking from the fourth visualization and thereafter repeating the step of requesting the individual engage in the fourth visualization.
